(19) United States
(12) Patent Application Publication
(10) Pub. No.: US 2014/0185717 A1
(43) Pub. Date: Jul. 3, 2014

(54) APPARATUS AND METHOD FOR FRAME SYNC DETECTION

(71) Applicant: KOREA ELECTRONICS TECHNOLOGY INSTITUTE, (US)

(72) Inventors: Kyung Taek LEE, Gyeonggi-do (KR); Yong Suk PARK, Seoul (KR); Seong Jun KIM, Seoul (KR); Kyung Won PARK, Seoul (KR)

(73) Assignee: KOREA ELECTRONICS TECHNOLOGY INSTITUTE, Gyeonggi-do (KR)

(21) Appl. No.: 13/775,898

(22) Filed: Feb. 25, 2013

(30) Foreign Application Priority Data
Dec. 27, 2012 (KR) 10-2012-0154002

(51) Int. Cl. H04L 7/04

(52) U.S. Cl. CPC H04L 7/042
USPC 375/343

(57) ABSTRACT

An apparatus includes: first to N−1-th correlation-calculation units correlation-calculating a signal at a position corresponding to an n-th reference cell of a reference symbol in a received symbol and a signal at a position corresponding to an n+1-th reference cell of the reference symbol in the received symbol; a first calculation unit multiplying a result of phase correlation calculation of the n-th reference cell and the n+1-th reference cell by the calculation result of the correlation-calculation units and thereafter, summing up all of the multiplication results to calculate a first sum total; a second calculation unit multiplying a result of phase correlation calculation of an N−n−2-th reference cell and an N−n−1-th reference cell by the calculation result of the correlation-calculation units and summing up all of the multiplying results to calculate a second sum total; and a decider detecting a larger value between the first and the second sum total.

### CROSS-REFERENCE TO RELATED APPLICATIONS

This application claims priority under 35 U.S.C. §119 to Korean Patent Application No. 10-2012-0154002, filed on Dec. 27, 2012, in the Korean Intellectual Property Office, the disclosure of which is incorporated herein by reference in its entirety.

### TECHNICAL FIELD

The present invention relates to an OFDM receiver, and more particularly, to an apparatus and a method for detection that can detect frame synchronization.

### BACKGROUND

The orthogonal frequency division multiplexing (OFDM) based Digital Radio Mondiale (DRM) Plus has been standardized in September 2009 by European Broadcasting Union (EBU) to cover VFH broadcasting band (up to Band III).

DRM Plus can offer better sound quality compared to analog frequency modulation (FM) radio broadcasting systems with maximum data transmission rate of 185 kbit/s in 100 kHz of bandwidth.

Many countries are considering DRM Plus as the digital replacement for the existing analog FM broadcasting.

However, in the digital broadcasting system, long delays are incurred in service start time after tuning into a particular frequency because several synchronization steps like symbol timing synchronization, frame synchronization, carrier frequency offset (CFO) & sampling frequency offset (SFO) compensation are necessary.

Therefore, the operation of the synchronization block causes several hundred milliseconds to few seconds of delay until the start of radio service after frequency tuning.

Furthermore, if reversed spectrum signals are transmitted in digital broadcasting systems, the receivers are unable to decode them, even though most receivers can demodulate the reversed spectrum signal in the analog radio broadcasting system.

### SUMMARY

The present invention has been made in an effort to provide an apparatus and a method for frame synchronization detection that can detect frame synchronization and frequency spectrum inversion.

An exemplary embodiment of the present invention provides an apparatus for frame synchronization detection including: first to N−1-th correlation-calculation units correlation-calculating a signal at a position corresponding to an n-th reference cell of a reference symbol in a received symbol and a signal at a position corresponding to an n+1-th reference cell of the reference symbol in the received symbol; a first calculation unit respectively multiplying a result of phase correlation calculation of the n-th reference cell and the n+1-th reference cell by each of the calculation result of the first to N−1-th correlation-calculation unit and thereafter, summing up all of the multiplication results to calculate a first sum total; a second calculation unit respectively multiplying a result of phase correlation calculation of an N−n−2-th reference cell and an N−n−1-th reference cell by each of the calculation result of the first to N−1-th correlation-calculation unit and thereafter, summing up all of the multiplexing results to calculate a second sum total; and a decider detecting a larger value between an absolute real number value of the first sum total and an absolute real number value of the second sum total, in which the N represents a total number of the reference cells included in the reference symbol and n, which represents a degree of the reference symbol, is 0≦n≦N−2.

Another exemplary embodiment of the present invention provides a method for frame synchronization detection, including: correlation-calculating an n-th signal at a position corresponding to an n-th reference cell of a reference symbol in a received symbol and an n+1-th signal at a position corresponding to an n+1-th reference cell in the received symbol; respectively multiplying a result of phase correlation calculation of the n-th reference cell and the n+1-th reference cell by each of the correlation-calculation result of the n-th signal and the n+1-th signal of the received symbol and thereafter, summing up all of the multiplication results to calculate a first sum total; respectively multiplying a result of phase correlation calculation of an N−n−2-th reference cell and an N−n−1-th reference cell by each of the correlation-calculation result of the n-th signal and the n+1-th signal of the received symbol and thereafter, summing up all of the multiplication results to calculate a second sum total, simultaneously with the calculating of the first sum total or subsequent to the calculating of the first sum total; and detecting a larger value between an absolute real number value of the first sum total and an absolute real number value of the second sum total, in which the N represents a total number of the reference cells included in the reference symbol and n is 0≦n≦N−2.

Other features and aspects will be apparent from the following detailed description, the drawings, and the claims.

### BRIEF DESCRIPTION OF THE DRAWINGS

FIG. 1 is a configuration diagram illustrating an apparatus for frame synchronization detection according to an exemplary embodiment of the present invention.

FIG. 2 is a flowchart illustrating a method for frame synchronization detection according to another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In general, a digital radio receiver demodulates a received signal and thereafter, conjugates the demodulated signal with an original signal. However, when a receiver Fourier-transforms a signal of which a frequency spectrum is inverted whereupon sends the Fourier-transformed signal to a frequency domain, a carrier index of the inverted signal is inverted on frequency domain. As a result, the inverted signal may not be decoded by a method in the related art. In order to prevent the problem, in an exemplary embodiment of the present invention, it is also possible to detect whether a received signal is inverted at the time of detecting frame synchronization.

Hereinafter, a feature of a frame of a DRM Plus standard will be described before describing a detailed configuration of the present invention.

A first OFDM symbol of the DRM Plus frame has 34 reference cells (pilot signal) as illustrated in Table 1 below. Herein, the reference cells include a gain reference cell (GRC) and a time reference cell (TRC).

TABLE 1

| | Carrier | |
|---|---|---|
| | Index | Type |
| 1 | −94 | GRC |
| 2 | −80 | TRC |
| 3 | −79 | TRC |
| 4 | −78 | GRC |
| 5 | −77 | TRC |
| 6 | −62 | GRC |
| 7 | −53 | TRC |
| 8 | −52 | TRC |
| 9 | −51 | TRC |
| 10 | −46 | GRC |
| 11 | −32 | TRC |
| 12 | −31 | TRC |
| 13 | −30 | GRC |
| 14 | −14 | GRC |
| 15 | 2 | GRC |
| 16 | 12 | TRC |
| 17 | 13 | TRC |
| 18 | 14 | TRC |
| 19 | 18 | GRC |
| 20 | 21 | TRC |
| 21 | 22 | TRC |
| 22 | 23 | TRC |
| 23 | 34 | GRC |
| 24 | 40 | TRC |
| 25 | 41 | TRC |
| 26 | 42 | TRC |
| 27 | 50 | GRC |
| 28 | 66 | GRC |
| 29 | 67 | TRC |
| 30 | 68 | TRC |
| 31 | 79 | TRC |
| 32 | 80 | TRC |
| 33 | 82 | GRC |
| 34 | 98 | GRC |

Similarly, other OFDM symbols of the DRM Plus frame also include one or more reference cells. Of course, the other OFDM symbols may include reference cells at unique positions different from the first OFDM symbol.

In general, in communication of consecutive signals, such as radio broadcasting, the received signal and an already known reference symbol are correlation-calculated in order to acquire frame synchronization of a received signal. The present invention also uses this way to acquire frame synchronization of a DRM Plus received signal. In this case, the reference symbol may be one of the OFDM symbols of the frame, but a case using the first OFDM symbol of the frame is described as an example in the exemplary embodiment so as to facilitate detection of a start timing of the frame.

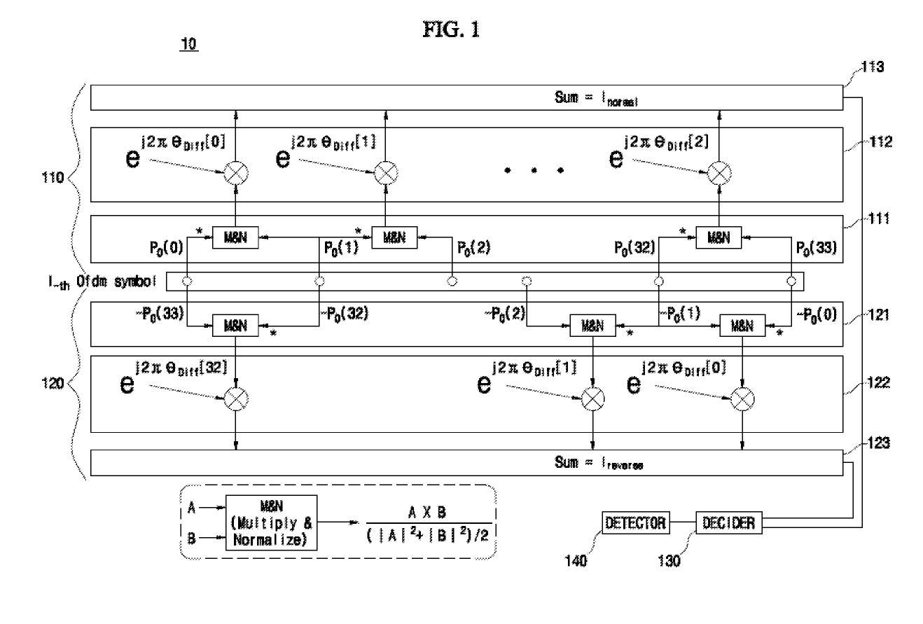

Hereinafter, exemplary embodiments of the present invention will be described. FIG. 1 is a configuration diagram illustrating an apparatus for frame synchronization detection according to an exemplary embodiment of the present invention.

As illustrated in FIG. 1, a detection apparatus 10 according to the exemplary embodiment of the present invention includes a first block 110, a second block 120, a decider 130, and a detector 140. Herein, the detection apparatus 10 may be a frame synchronization detecting apparatus.

The first block 110 is a block that performs correlation calculation of a received symbol and a reference symbol on the assumption that a frequency spectrum of a received signal is not inverted. The first block 110 includes a plurality of 1−1-th calculation units 111, a plurality of 1−2-th calculation units 112, and a 1−3-th calculation unit 113. Hereinafter, each unit will be described.

The plurality of 1−1-th calculation units 111 correlation-calculates a signal R₁[P₀(n)] at a position corresponding to an n-th reference cell P₀(n) of an 1-th received symbol and a signal R₁[P₀(n+1)] at a position corresponding to an n+1-th reference cell P₀(n+1) adjacent thereto and thereafter, normalizes the correlation-calculated signals, as illustrated in Equation 1 below. Herein, the received symbol is each OFDM symbol on a frequency domain in which the received signal is Fourier-transformed.

$${M}_{n} = \frac{{R}_{l} * [ {P}_{0} ( n ) ] \cdot {R}_{l} [ {P}_{0} ( n + 1 ) ]}{( {\vert {R}_{l} [ {P}_{0} ( n ) ] \vert}^{2} + {\vert {R}_{l} [ {P}_{0} ( n + 1 ) ] \vert}^{2} ) / 2} \qquad [ Equation 1 ]$$

The plurality of 1−2-th calculation units 112 correlation-calculates an already known phase correlation value of two reference cells and a calculation result of the plurality of 1−1-th calculation units 111. That is, the plurality of 1−2-th calculation units 112 performs calculation of Mₙ·e^{j2πθ}^{_{diff}}⁽ⁿ⁾.

In this case, the already known phase correlation value of two reference cells (n-th reference cell and n+1-th reference cell) may be calculated by using Equation 2 below.

θ_{diff}(n)=/{X₀*[P₀(n)]·X₀[P₀(n|1)]} [Equation 2]

In Equation 2 above, X₀[P₀(n)] represents an n-th reference cell of the first OFDM symbol of the frame and X₀[P₀(n+1)] represents an adjacent cell of the n-th reference cell. Herein, n is 0≦n≦Nᵣₑ−2 and Nᵣₑ represents a total number of reference cells included in the reference symbol.

The 1−3-th calculation unit 113 calculates a sum total of a calculation result of the plurality of 1−2-th calculation units 112 as illustrated in Equation 3 below.

$${l}_{normal} = {\sum }_{n = 0}^{{N}_{re} - 2} {M}_{n} \cdot {e}^{j 2 π {θ}_{diff} ( n )} \qquad [ Equation 3 ]$$

Herein, Nᵣₑ is 34 when the first OFDM symbol of the frame is used as the reference symbol and when other OFDM symbols are used as the reference symbol, Nᵣₑ may vary.

The second block 120 is a block that performs correlation calculation of the received symbol and the reference symbol on the assumption that the frequency spectrum is inverted. The second block 120 includes a plurality of 2−1-th calculation units 121, a plurality of 2−2-th calculation units 122, and a 2−3-th calculation unit 123.

The plurality of 2−1-th calculation units 121 correlation-calculates a signal R₁[−P₀(n)] at a position corresponding to an n-th reference cell P₀(n) of an 1-th received symbol and a signal R₁[−P₀(n+1)] at a position corresponding to an n+1-th reference cell P₀(n+1) which is an adjacent cell thereto and thereafter, normalizes the correlation-calculated signals, as illustrated in Equation 4 below. In this case, inputs of the plurality of 2−1-th calculation units 121 of FIG. 1 and input signals of Equation 4 below are illustrated on the assumption that the frequency spectrum of the received symbol is inverted for easy description. However, since the plurality of 2−1-th calculation units 121 and the plurality of 1−1-th calculation units 111 perform substantially the same calculation with respect to the received symbol, one of the plurality of 2−1-th calculation units 121 and the plurality of 1−1-th calculation units may not be provided.

$${M}_{n}^{′} = \frac{{R}_{l} * [ - {P}_{0} ( n ) ] \cdot {R}_{l} [ - {P}_{0} ( n + 1 ) ]}{( {\vert {R}_{l} [ - {P}_{0} ( n ) ] \vert}^{2} + {\vert {R}_{l} [ - {P}_{0} ( n + 1 ) ] \vert}^{2} ) / 2} \qquad [ Equation 4 ]$$

The plurality of 2−2-th calculation units 122 correlation-calculates an already known phase correlation value of reciprocal numbers of two reference cells and a calculation result of the plurality of 2−1-th calculation units 121. Herein, the plurality of 2−2-th calculation units 122 uses X₀[P₀(Nᵣₑ−n−2)] and X₀[P₀(Nᵣₑ−n−1)] corresponding to the reference symbol in which the frequency spectrum is inverted as the already known reciprocal numbers of two reference cells.

In this case, when only one of the plurality of 1−1-th calculation units 111 and the plurality of 2−1-th calculation units 121 is provided, the plurality of 2−2-th calculation units 122 receives the calculation result of one provided between the plurality of 1−1-th calculation units 111 and the plurality of 2−1-th calculation units 121 to correlation-calculate the received calculation result and phase values of the already known reciprocal numbers of two reference cells.

The 2−3-th calculation unit 123 calculates a sum total of a calculation result of the plurality of 2−2-th calculation units 122 as illustrated in Equation 5 below.

$${l}_{reverse} = {\sum }_{n = 0}^{{N}_{re} - 2} {M}_{n}^{′} \cdot {e}^{j 2 π {θ}_{diff} ( n )} \qquad [ Equation 5 ]$$

Meanwhile, the plurality of 1−1-th calculation units 111, the plurality of 1−2-th calculation units 112, the plurality of 2−1-th calculation units 121, and the plurality of 2−2-th calculation units 122 may be provided as many as at least Nᵣₑ−1 so as to simultaneously perform the aforementioned correlation-calculation with respect to signals of received symbols corresponding to all reference cells included in the first OFDM symbol.

The decider 130 outputs a large value among the absolute real number values of the calculation results of Equations 3 and 5 as illustrated in Equation 6 below. Herein, [symbol] re{lₙₒᵣₘₐₗ} and [symbol] re{lᵣₑᵥₑᵣₛₑ}. In this case, the decider 130 may receive the absolute real number values from the 1−3-th calculation unit 113 and the 2−3-th calculation unit 123. In this case, the decider 130 only outputs the larger value among them.

[symbol]

=arg maxₗ{| [symbol] ,| [symbol] [Equation 6]

The decider 130 decides that the frequency spectrum of the received symbol is inverted when | [symbol] is larger than [symbol] and otherwise, the decider 130 decides that the frequency spectrum is not inverted.

The decider 130 notifies at least one of the detector 130 and a decoding unit (not illustrated) of whether the frequency spectrum is inverted, thereby allowing the decoding unit (not illustrated) to decode the received symbol considering the inversion of the frequency spectrum.

By the aforementioned method, the first block 110 and the second block 120 sequentially perform the aforementioned calculation with respect to the subsequent received symbols from the 1-th received symbol to calculate a calculation result of Equation 6 with respect to all symbols included in one frame.

The detector 140 verifies the calculation results of Equation 6 of the decider 130 corresponding to the number of symbols included in one frame and detects a symbol in which the calculation result of Equation 6 is the largest among them, as a start symbol of the frame.

For example, when a transmission symbol is Abcdefg (total 7 symbols, A: the first OFDM symbol of the frame, b to g: OFDM symbols), a transmitter transmits the transmission symbol like “AbcdefgAbcdefgAbcdefgAbcdefgAbcdefg˜˜”. In this case, the receiver may receive the received symbols in the order of “efgAbcdefgAbcdefgAbcdefgAbcd˜˜”. The receiver needs to verify whether any symbol among the received symbols is the start symbol of the frame in order to accurately decode the frame.

To this end, as described below, the detection apparatus 10 according to the exemplary embodiment of the present invention performs correlation calculation of a signal corresponding to a reference cell of a received symbol “e” which is received most first and a reference cell of an already known reference symbol “A” and similarly, performs correlation calculation even with respect to f, g, A, b, c, and d.

<Correlation Calculation Order>
e*·A
f*·A
g*·A
A*·A→has the largest value
b*·A
c*·A
d*·A

The detector 140 may verify that a result of correlation calculation of a fourth received symbol is the largest and verify that the fourth received symbol is the start point of the frame, as the aforementioned calculation result.

Meanwhile, in the aforementioned example, a case in which the detector 140 detects the start symbol of the frame using the result of Equation 6 has been described as an example. However, the detector 140 may also detect the start point of the frame using Equation 3 or 5 according to whether the frequency spectrum is inverted.

As such, in the exemplary embodiment of the present invention, while frame synchronization is detected, whether the frequency spectrum is inverted may be verified together, and as a result, a delay time for detecting the inversion of the frequency spectrum in digital broadcasting may be reduced.

Further, the exemplary embodiment of the present invention may provide excellent frame synchronization and spectrum inversion detection probability even in a weak DRM Plus signal by using the first OFDM symbol of the frame as the reference symbol.

Further, in the exemplary embodiment of the present invention, as the correlation calculation result of the received symbol and the reference symbol is normalized, excellent detection performance aboutframe synchronization and frequency spectrum inversion may be secured even under an environment in which signal intensity varies, such as a mobile environment.

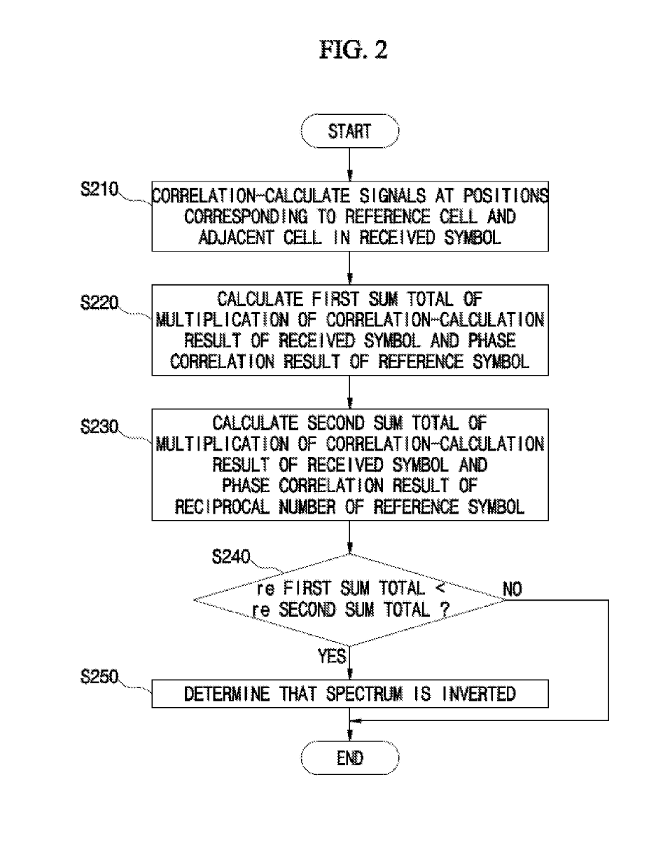

Hereinafter, a detection method according to an exemplary embodiment of the present invention will be described with reference to FIG. 2. FIG. 2 is a flowchart illustrating a method for frame synchronization detection according to an exemplary embodiment of the present invention.

Referring to FIG. 2, as illustrated in Equation 1 or 4, a detection apparatus 10 correlation-calculates a signal at a position corresponding to an n-th reference cell of a reference symbol in an 1-th received symbol and a signal at a position corresponding to an n+1-th reference cell (adjacent cell) in the 1-th received symbol (S210). In this case, if the spectrum of the received symbol is inverted, a result of Equation 4 will be obtained and otherwise, a result of Equation 1 will be obtained.

The detection apparatus 10 respectively multiplies a result of phase correlation of the n-th reference cell and the n+1-th reference cell by a correlation-calculation result at the positions corresponding to the reference cell and the adjacent cell of the received symbol and thereafter, sums up all of the results to calculate a first sum total (S220).

Substantially simultaneously with step S220 or after step S220, the detection apparatus 10 respectively multiplies a result of phase correlation of an N−n−2-th reference cell and an N−n−1-th reference cell by a correlation-calculation result at the positions corresponding to the reference cell and the adjacent cell of the received symbol and thereafter, sums up all of the results to calculate a second sum total (S230). Herein, the N−n−2-th reference cell and the N−n−1-th reference cell may correspond reference cells to be detected from the received symbol when the received symbol is the first OFDM symbol of the frame and the frequency spectrum thereof is inverted.

The detection apparatus 10 compares an absolute real number value of the first sum total and an absolute real number value of the second sum total with each other (S240).

The detection apparatus 10 determines that the spectrum of the received symbol is inverted when the absolute real number value of the second sum total is a larger value as the comparison result (S250). In this case, the detection apparatus 10 notifies the inversion of the spectrum of the received symbol to a decoding apparatus, thereby allowing the decoding apparatus to decode the received symbol considering the inversion of the spectrum.

The detection apparatus 10 performs the aforementioned steps with respect to received symbols corresponding to a total number of OFDM symbols included in one frame by performing the aforementioned steps even with respect to frames after the 1-th received symbol. In addition, the detection apparatus 10 may detect, as a start point of the frame, a received symbol including the largest value among larger detected real number values (see Equation 6) by a result of performing the aforementioned steps.

As such, in the exemplary embodiment of the present invention, while frame synchronization is detected, whether the frequency spectrum is inverted may be verified together, and as a result, a delay time for detecting the inversion of the frequency spectrum may be reduced.

Further, the exemplary embodiment of the present invention may provide high frame synchronization and spectrum inversion detection probability even in a weak DRM Plus signal by using the first OFDM symbol of the frame as the reference symbol.

Further, in the exemplary embodiment of the present invention, as the correlation calculation result of the received symbol and the reference symbol is normalized, excellent detection performance of frame synchronization and spectrum inversion may be secured even under an environment in which signal intensity varies, such as a mobile environment.

According to the exemplary embodiments of the present invention, even when the frequency spectrum is inverted, it is possible to support the DRM Plus signal to be decoded.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for frame synchronization detection, comprising:
first to N−1-th correlation-calculation units correlation-calculating a signal at a position corresponding to an n-th reference cell of a reference symbol in a received symbol and a signal at a position corresponding to an n+1-th reference cell of the reference symbol in the received symbol;
a first calculation unit respectively multiplying a result of phase correlation calculation of the n-th reference cell and the n+1-th reference cell by each of the calculation result of the first to N−1-th correlation-calculation unit and thereafter, summing up all of the multiplication results to calculate a first sum total;
a second calculation unit respectively multiplying a result of phase correlation calculation of an N−n−2-th reference cell and an N−n−1-th reference cell by each of the calculation result of the first to N−1-th correlation-calculation unit and thereafter, summing up all of the multiplexing results to calculate a second sum total; and
a decider detecting a larger value between an absolute real number value of the first sum total and an absolute real number value of the second sum total,
wherein the N represents a total number of the reference cells included in the reference symbol and the n, which is a degree of the reference symbol, is 0≦n≦N−2.

2. The apparatus of claim 1, wherein the first to N−1-th correlation-calculation units normalize respectively correlation-calculated results of signals at positions corresponding to the n-th reference cell and the n+1-th reference cell and provides the normalized results to the first calculation unit and the second calculation unit.

3. The apparatus of claim 1, wherein the decider decides that a spectrum of the received symbol is inverted when the larger value is the absolute real number value of the second sum total.

4. The apparatus of claim 1, further comprising:
a detector detecting, as a start point of the frame, a received symbol including the largest value among the larger values detected with respect to a plurality of received symbols corresponding to the number of frames including the received symbols.

5. The apparatus of claim 1, wherein the first calculation unit calculates the first sum total by an Equation below,
$$= re \{ {\sum }_{n = 0}^{N - 2} \frac{{R}_{l} * [ {P}_{0} ( n ) ] \cdot {R}_{l} [ {P}_{0} ( n + 1 ) ]}{( {\vert {R}_{l} [ {P}_{0} ( n ) ] \vert}^{2} + {\vert {R}_{l} [ {P}_{0} ( n + 1 ) ] \vert}^{2} ) / 2} \cdot {e}^{j 2 π {θ}_{diff} ( n )} \}$$
$${θ}_{diff} ( n ) = ∠ \{ {X}_{0} * [ {P}_{0} ( n ) ] \cdot {X}_{0} [ {P}_{0} ( n + 1 ) ] \}$$
wherein R₁[P₀(n)] represents the signal at a position corresponding to the n-th reference cell, R₁[P₀(n+1)] represents the signal at a position corresponding to the n+1-th reference cell, X₀[P₀(n)] represents the n-th reference cell, and X₀[P₀(n+1)] represents the n+1-th reference cell.

6. A method for frame synchronization detection, comprising:
correlation-calculating an n-th signal at a position corresponding to an n-th reference cell of a reference symbol in a received symbol and an n+1-th signal at a position corresponding to an n+1-th reference cell in the received symbol;
respectively multiplying a result of phase correlation calculation of the n-th reference cell and the n+1-th reference cell by each of the correlation-calculation result of the n-th signal and the n+1-th signal of the received symbol and thereafter, summing up all of the multiplication results to calculate a first sum total;
respectively multiplying a result of phase correlation calculation of an N−n−2-th reference cell and an N−n−1-th reference cell by each of the correlation-calculation result of the n-th signal and the n+1-th signal of the received symbol and thereafter, summing up all of the multiplication results to calculate a second sum total, simultaneously with the calculating of the first sum total or subsequent to the calculating of the first sum total; and
detecting a larger value between an absolute real number value of the first sum total and an absolute real number value of the second sum total,
wherein the N represents a total number of the reference cells included in the reference symbol and n is 0≦n≦N−2.

7. The method of claim 6, further comprising:
deciding that a spectrum of the received symbol is inverted when the larger value is the absolute real number value of the second sum total.

8. The method of claim 6, wherein:
when the correlation calculating includes normalizing the results of respectively correlation-calculating the n-th reference cell and the n+1-th reference cell,
the calculating of the first sum total and the calculating of the second sum total use the normalized correlation-calculation result.
